(19) United States
(12) Patent Application Publication
(10) Pub. No.: US 2008/0066411 A1
(43) Pub. Date: Mar. 20, 2008

(54) Muntin Bar Joiner

(75) Inventor: Michael A. Tyler, Mokena, IL (US)

Correspondence Address: BANNER & WITCOFF, LTD., TEN SOUTH WACKER DRIVE, SUITE 3000, CHICAGO, IL, 60606, US

(73) Assignee: Newell Operating Company, Atlanta, GA (US)

(21) Appl. No.: 11/857,220

(22) Filed: Sep. 18, 2007

Related U.S. Application Data
(60) Provisional application No. 60/845,349, filed on Sep. 18, 2006.

(51) Int. Cl. E06B 3/663

(52) U.S. Cl. 52/456

(57) ABSTRACT

A muntin bar joiner is adapted to be connected to a first muntin bar and a second muntin bar. The muntin bar joiner has a base adapted to be connected to a first muntin bar. The base has a cap sized to extend beyond a first opening in the first muntin bar. The muntin bar joiner also has a bar support extending from the base member and adapted for connection to a second muntin bar.

### CROSS-REFERENCE TO RELATED APPLICATIONS

This application claims the benefit of and is a continuation-in-part application of U.S. Provisional Patent Application No. 60/845,349, filed Sep. 18, 2006, which is incorporated by reference herein and made part hereof.

### TECHNICAL FIELD

This invention relates generally to muntin grids for sash window assemblies and more specifically to a muntin bar joiner for connecting muntin bars positioned within a sash window.

### BACKGROUND OF THE INVENTION

Double hung window assemblies typically include a pair of sash windows slidably mounted within a master frame. In the past, sash windows were provided with a grid of muntin bars, typically made of wood, that separated and held multiple panes of glass within a sash. Each pane would be mounted within the sash in the same plane. Now, double or multiple pane windows are provided, otherwise known as insulated or thermo-pane window assemblies. These insulated window assemblies include a pair of glass panes mounted in parallel relation to one another within a sash frame and separated by a small distance. The panes are typically separated by a spacer frame located about a periphery of the panes. Of course, insulated or thermo pane windows are not limited to single or double hung window arrangements. Rather, they have a wide range of applications that are well known in the art. For instance, double pane windows may be incorporated in doors, picture windows, etc.

Grids formed by interconnected muntin bars are often installed between these glass panes of a double pane or insulated sash window. Typically, these grids are comprised of multiple muntin bars arranged in a grid pattern and interconnected at interior intersecting points by muntin bar joiners. The grid is then placed between the panes of glass. The periphery of the grid is then mounted to the sash frame, or more typically, to a spacer frame separating the panes, by a series of muntin clips. It is understood that the grid can take a variety of different forms as desired.

Typically, the muntin bars are of a tubular or hollow construction and a portion of the muntin clip is received by an end of a muntin bar located at a periphery of the grid. The muntin bars can start from a flat piece of material in some embodiments and bent into a tubular configuration. Typically, the hollow muntin bar receives an extension or bar support of the clip that is designed to fit tightly within the hollow muntin bar to affect an interference fit, thereby attaching the muntin clip to the muntin bar end. (See FIG. 3) The clip in turn is attached or connected in some way to the spacer frame. An example of a prior art muntin clip is shown in cross section in FIG. 3. The prior art muntin clip 1 includes a bar support 2, in the form of a tree, tightly fitting within and received by a muntin bar 3.

Muntin grids, including the bars, joiners and clips of which they are comprised, come in numerous shapes and sizes. One drawback resulting from this fact is that muntin clip manufactures must design and produce a separate clip to match each potential size/shape of muntin bar available on the market and to also match with a variety of sizes of spacer frames. A conservative estimate is that there are currently at least 500 muntin clip designs available on the market to accommodate the multitude of sizes and shapes that can be found in the available muntin bars. This costs clip manufacturers, and window manufacturers or assemblers to incur costs associated with maintaining and otherwise dealing with large and varied inventories of muntin clips.

FIGS. 4-5 show a spacer frame. The spacer frame typically has a lateral wall having a length C, a pair of vertical walls having a height B, and a pair of shoulders, each having a length X. The shoulders are separated by a distance A. As one might expect, various window designs may and do require variously sized spacer frames. Typically, a manufacturer will adjust the length of the lateral wall C to accommodate window designs having differing widths between their multiple panes of glass. However, for each different value of C (length of lateral or bottom wall), the height B of the vertical wall and the length of the shoulder X remain as constants. Therefore, as the length C of the lateral wall varies between the various required spacer frame designs, the distance A between the shoulders also varies. This distance plays a role in determining what muntin clip may be used with a particular spacer frame.

Accordingly it can be seen that there are at least two factors dictating what type or design of muntin clip may be used in a particular window assembly. First is the configuration of the muntin bar to be used. The second factor is the configuration of the spacer frame. The multitude of variations available in both muntin bars and spacer frames results in the present existence of at least 500 different muntin clip designs currently being available. This in turn causes clip manufacturers and window assemblers to be burdened with large clip inventories. In addition, certain muntin clip designs require complex molds in the manufacturing process.

Different types of muntin bar joiners are known the art. Muntin bar joiners typically join or connect a first muntin bar with a second muntin bar. In certain configurations, the muntin bars are connected in a T-shaped wherein the second muntin bar extends from the first muntin bar in a generally transverse or right angle configuration. In such configuration, the second muntin bar extends from only one side of the first muntin bar and does not cross the first muntin bar. While such muntin bar joiners have certain desirable features, the prior art joiners also have certain drawbacks. For example, certain muntin bar joiners utilize a small, generally circular hole formed in the muntin bar for mounting thereto. The small mounting hole, however, remains open and visible through the sash window assembly and is generally considered unsightly and not aesthetically pleasing. Portions of the muntin bar joiner often protrude through the mounting hole. At times, efforts are made to cover the opening with paint or tape members but such efforts are still unsatisfactory. In addition, some muntin bar joiners are limited in the types of muntin bar configurations for which the joiners can be utilized.

The present invention is provided to solve the problems discussed above and other problems, and to provide advantages and aspects not provided by prior muntin bar joiners of this type. A full discussion of the features and advantages of the present invention is deferred to the following detailed description, which proceeds with reference to the accompanying drawings.

### SUMMARY OF THE INVENTION

The present invention provides a muntin bar joiner with improved connection characteristics for muntin bar grids.

According to one aspect of the invention, a muntin bar joiner is a three-way muntin bar joiner configured to join a first muntin bar with a second muntin bar wherein the second muntin bar is generally transverse to the first muntin bar, in generally a T-shaped configuration.

According to another aspect of the invention, the first muntin bar has a first opening in communication with a second opening and the second muntin bar has a first opening. The muntin bar joiner has a base having a proximal end and a distal end. The base has a cap proximate the proximal end. The muntin bar joiner also has a bar support extending from the base. The base is adapted to be inserted through the first opening and the second opening of the first muntin bar wherein the cap is sized to extend beyond the first opening of the first muntin bar. The base is also adapted to be inserted into the first opening of the second muntin bar wherein the bar support is adapted to engage an inner surface of the second muntin bar.

According to another aspect of the invention, the cap has a generally planar outer surface. The surface is adapted to face into the sash window assembly. The cap also has rounded peripheral edges.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a perspective view of a sash window assembly including a muntin grid;

FIG. 2 is a partial cross sectional view of the window assembly of FIG. 1 taken along the line 2-2;

FIG. 3 is a side elevation view of a prior art muntin clip;

FIG. 4 is a partial isometric view of a spacer frame according to the present invention;

FIG. 5 is a cross section view of the spacer frame of FIG. 4 taken along the line 5-5 of FIG. 4;

FIG. 6 is a partial perspective view of a muntin bar end according to the present invention;

FIG. 7 is a perspective view of another sash window assembly having a muntin grid;

FIG. 8 is a perspective view of a muntin bar joiner according to the present invention;

FIG. 9 is a front elevation view of the muntin bar joiner shown in FIG. 8;

FIG. 10 is a rear perspective view of the muntin bar joiner shown in FIG. 8;

FIG. 11 is a rear elevation view of the muntin bar joiner shown in FIG. 8;

FIG. 12 is a side elevation view of the muntin bar joiner shown in FIG. 8;

FIG. 13 is a bottom view of the muntin bar joiner shown in FIG. 8;

FIG. 14 is a top view of the muntin bar joiner shown in FIG. 8;

FIG. 15 is a partial enlarged front elevation view of a proximal portion of the muntin bar joiner shown in FIG. 8;

FIG. 16 is a partial enlarged front perspective view of the proximal portion of the muntin bar joiner shown in FIG. 8 and showing an underside surface of a cap of the muntin bar joiner;

FIG. 17 is a partial perspective view of the muntin bar joiner of FIG. 8 being inserted into a first muntin bar;

FIG. 18 is a partial side elevation view of the muntin bar joiner of FIG. 8 mounted to the first muntin bar;

FIG. 19 is a partial side elevation view of a second muntin bar being mounted onto the muntin bar joiner of shown in FIG. 17;

FIG. 20 is a partial side elevation view of the first muntin bar connected to the second muntin bar via the muntin bar joiner of FIG. 8;

FIG. 21 is a partial end view of the first muntin bar showing the cap of the muntin bar of FIG. 8;

FIG. 22 is a schematic side view showing the muntin bar joiner of FIG. 8 connecting the first muntin bar and the second muntin bar;

FIG. 23 is a perspective view of another embodiment of the muntin bar joiner according to the present invention;

FIG. 24 is another perspective view of the muntin bar joiner of FIG. 23;

FIG. 25 is a front elevation view of the muntin bar joiner of FIG. 23;

FIG. 26 is a side elevation view of the muntin bar joiner of FIG. 23;

FIG. 27 is a bottom view of the muntin bar joiner of FIG. 23;

FIG. 28 is a top view of the muntin bar joiner of FIG. 23;

FIG. 29 is a perspective view of another embodiment of a muntin bar joiner according to the present invention;

FIG. 30 is a front elevation view of the muntin bar joiner shown in FIG. 29;

FIG. 31 is a side view of the muntin bar joiner shown in FIG. 29; and

FIG. 32 is a partial enlarged perspective view of the muntin bar joiner of FIG. 29.

### DETAILED DESCRIPTION

While this invention is susceptible of embodiment in many different forms, there are shown in the drawings and will herein be described in detail preferred embodiments of the invention with the understanding that the present disclosure is to be considered as an exemplification of the principles of the invention and is not intended to limit the broad aspect of the invention to the embodiments illustrated.

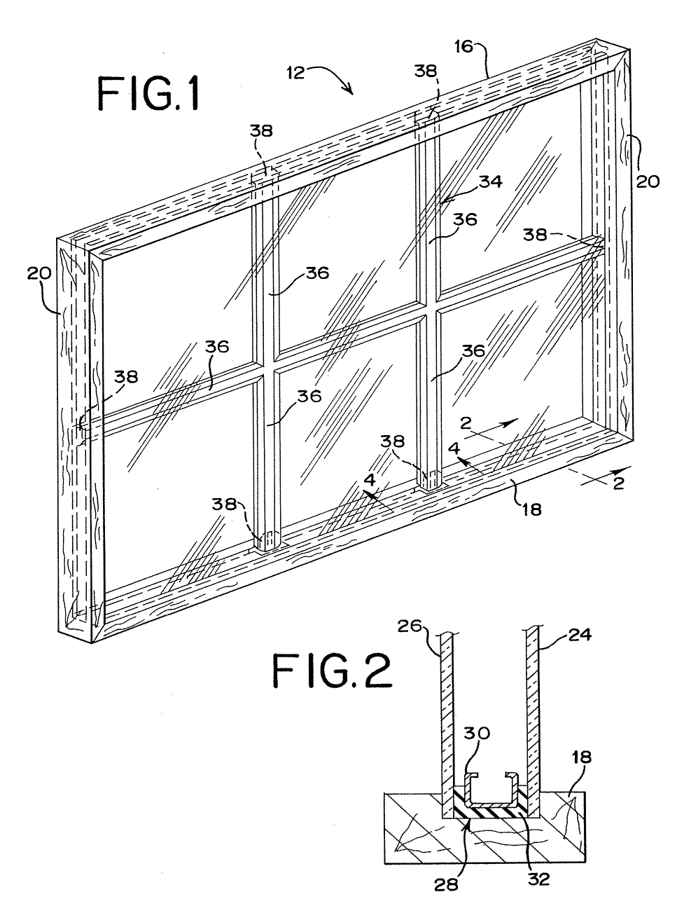

FIG. 1 shows a sash window 12 comprised of a top sash rail 16, a base sash rail 18 and a pair of vertical stiles 20. Although not shown, the sash window 12 may be mounted, slidingly or otherwise, within a master frame, such as, in a single or double hung window arrangement as is well known in the art. It is also understood that other hardware can be incorporated into the sash window 12 as is known in the art.

As shown in FIG. 2, each sash window 12 also includes a first pane of glass 24 and a second pane of glass 26 mounted in parallel relationship to one another within an interior of the sash window 12. The first and second panes 24, 26 are spaced by a spacer assembly 28 located at a periphery of the panes 24, 26. The spacer assembly 28 comprises a spacer frame 30 and a seal or sealant 32. The spacer frame 30 is generally tubular with a rectangular or square cross section as seen in FIG. 2. The spacer frame 30 extends about the entire periphery of the first and second panes 24, 26. A seal or sealant 32 is applied to an outer region of the spacer frame 30. When pressed between the first and second panes 24, 26, the spacer frame 30 forms an air tight seal between the two panes 24, 26.

A muntin grid 34 (FIG. 1) is positioned between the first and second panes of glass 24, 26. The muntin grid 34 is comprised of a plurality of interconnecting muntin bars 36. Each muntin bar 36 has a generally tubular and hollow construction. Various means of inter-connecting the muntin bars 36 are known to those of ordinary skill in the art. Certain connectors are cross-shaped allowing four muntin bars to be attached to the connector resulting in a cross-shaped configuration. The connecting means of the present invention are described in further detail below. As can be seen from the figures, the muntin bars 36 are interconnected to form a grid 34 which is positioned between the first and second panes of glass 24, 26. Extending towards and located at a periphery of the grid 34 are a plurality of muntin bar ends 38. It is understood that the grid 34 can take a variety of forms.

FIGS. 4-5 depict the spacer frame 30. FIG. 4 shows only a portion of the length of the spacer frame 30. It can be seen that the spacer frame is generally U-shaped and includes a lateral wall 56 and a pair of vertical walls 58 extending in the same direction from the lateral wall 56. Each vertical wall 58 includes an inwardly extending shoulder 60 located near an end of its respective vertical wall 58 distal from the lateral wall 56. The shoulders 60 are separated by a distance A, defining an elongated opening 57 in the top of the spacer frame 30. The vertical walls 58 each have a height B. The lateral wall 56 has a length C and the shoulders 60 each have a length X. Spaced along a length of an inner edge of the shoulders 60 are a plurality of notches 62 (FIG. 4) adapted to receive the mount structure 110 of the clip 100, to be explained. It can be seen that each notch 62 on one shoulder 60 is generally opposed from a corresponding notch 62 on the other shoulder 60. The opposed notches 62 form a pair of notches 64. It can also be seen that two notch pairs 64 are usually located in proximity to one another. It is understood that the two notch pairs 64 are but one preferred embodiment.

A typical muntin bar end 38 is shown in FIG. 6, and includes opposed side walls 37 spaced by a distance W and opposed lateral walls 39 spaced by a distance T. Each muntin bar end 38 is normally hollow and rectangular (although other shapes are possible), and has an interior cavity 40 with interior walls 37a and interior walls 39a formed by opposed side walls 37 and opposed lateral walls 39 respectively. The muntin bar 36 may have a solid peripheral structure or formed from a flat segment of material and folded into a tubular structure. In such configuration, the muntin bar 36 has an open seam extending along a length of the bar 36. It is understood that a muntin bar end opposite to the muntin bar end 38 shown in FIG. 6 can be connected to a muntin bar joiner of the present invention. Particular connections between the muntin bars and the muntin bar joiners of the present invention will be described in greater detail below.

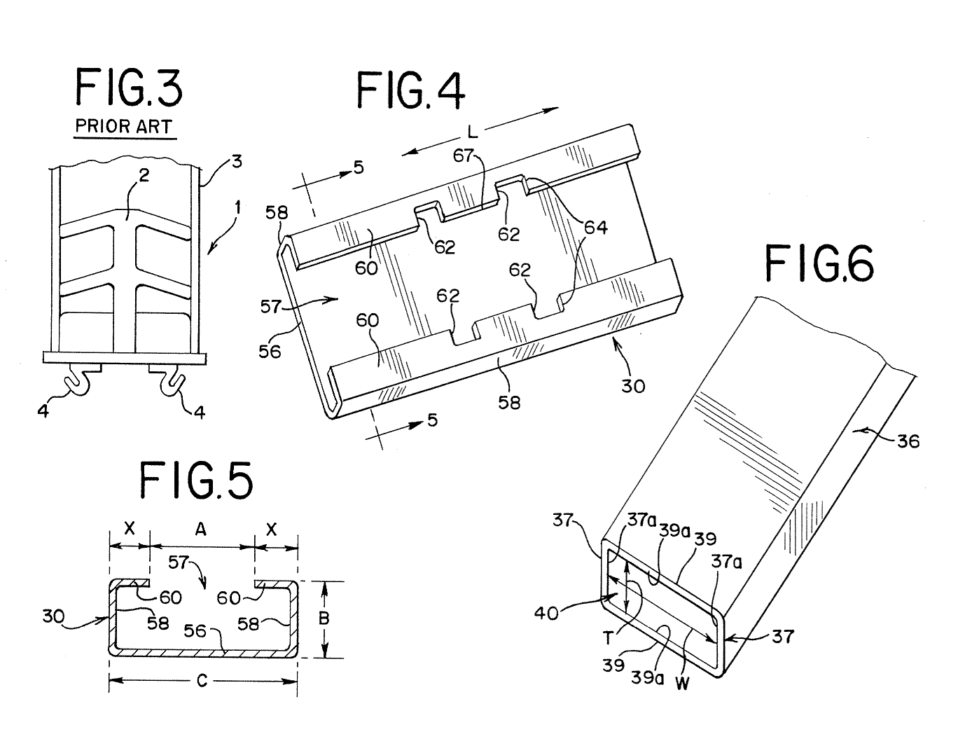

It is also understood that a muntin clip (FIG. 3) can mount certain muntin bar ends 38 to the sash window 12. The muntin clip has one end mounted to the muntin bar and another end mounted to the spacer frame as is known.

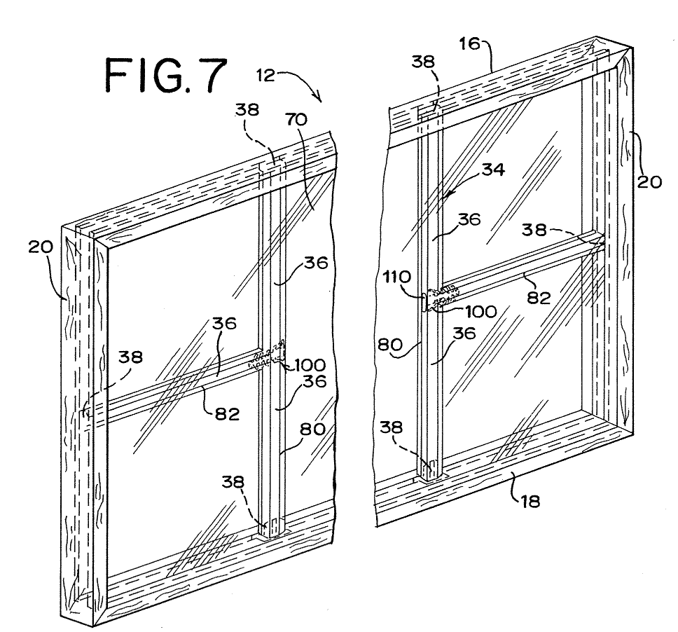

It is further understood that a muntin bar joiner is used to connect muntin bars to one another to form a muntin bar assembly or grid such as shown in FIG. 1. Certain muntin bar joiners are used to connect a plurality of muntin bars generally in a cross-shape such as shown in FIG. 1. Other grid configurations are also possible such as shown in FIG. 7 wherein it is desired for a central portion 70 of the sash window 12 to be free of any muntin grid. It is understood that the central portion 70 can vary in size as desired. In this instance, a muntin bar joiner, generally designated with the reference numeral 100, can be used to join a first muntin bar 80 with a second muntin bar 82 wherein the second muntin bar is generally transverse to the first muntin bar 80. The second muntin bar 82 may be considered to extend from one side of the first muntin bar 80 at generally a right angle and does not extend past an opposite side of the first muntin bar 80. The muntin bar joiner 100 in this configuration may be referred to as a three-way joiner. It is understood that the muntin bar joiner 100 joins the first muntin bar 80 and the second muntin bar 82 in a T-shape and wherein the bars 80, 82 can be arranged in various horizontal, vertical or angled configurations. The muntin bar joiner 100 will now be described in greater detail.

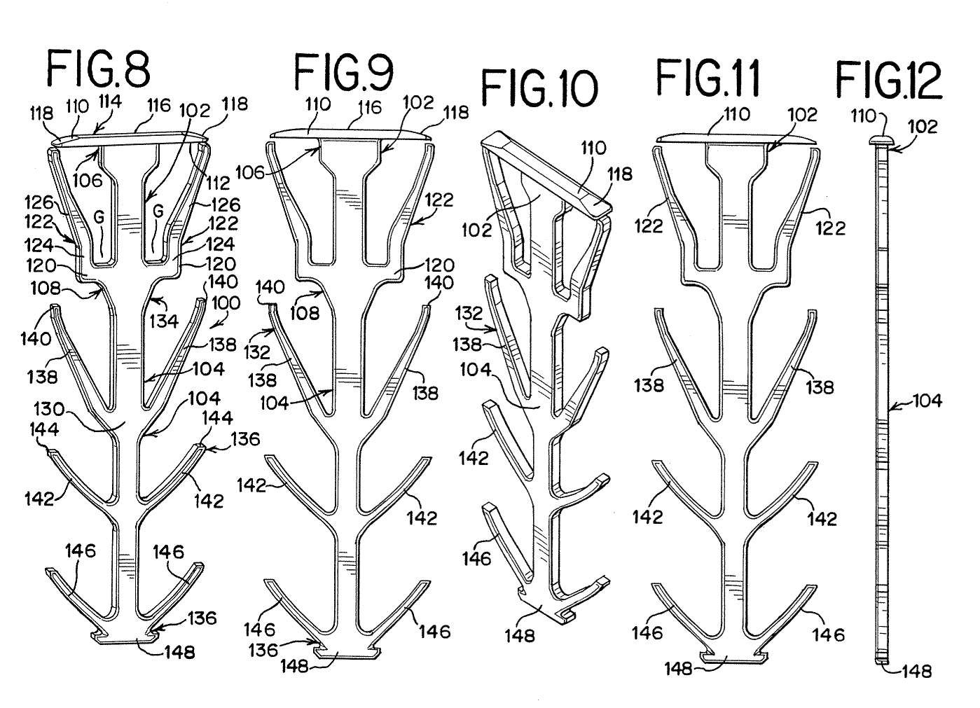

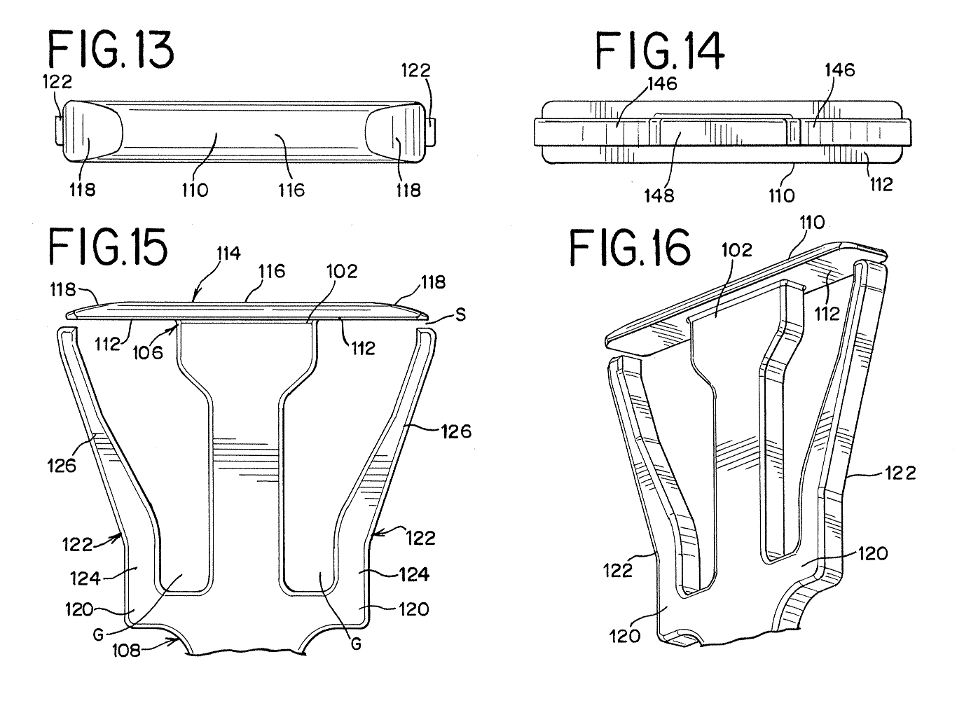

FIGS. 8-16 show one exemplary embodiment of a muntin bar joiner of the present invention. The muntin bar joiner 100 generally includes a base 102 and a bar support member 104. The bar support member 104 extends from and is supported by the base 102. As explained in greater detail below, the muntin bar joiner 100 has a plurality of fingers associated with the base 102 and the bar support member 104. Certain fingers may be considered legs that are associated with the base 102.

The base 102 has a generally bar-shaped support structure and has a proximal end 106 and a distal end 108. The base 102 may widen towards the proximal end 106. A cap 110 is provided at the proximal end 106 and is generally integral with the base 102 although the cap 110 could a separate structure suitably connected to the base 102. The cap 110 is connected at the base 102 at an inner surface 112 that is generally planar. The cap 110 has an outer surface 114 that has a generally planar central surface 116 and tapered ends 118. As described in greater detail below, the cap 110 is sized to positioned over and extend beyond peripheral edges of an opening in the muntin bar 80. The base 102 has a pair of shoulders 120 extending from proximate the distal end 108 of the base 102. A flexible leg 122 extends from a respective shoulder 120. The legs 122 extend towards the cap 110 and are in confronting relation to the inner surface 112 of the cap 110. In this embodiment, the legs 122 extend past the outer edges 118 of the cap 110. A space S is maintained between the inner surface 112 and the distal end of the legs 122. The legs 122 have a first portion 124 extending generally transverse to the shoulder 120 and a second portion 126 extending outwardly from the first portion 124 and away from the base 102. A gap G is maintained between the shoulders 120 and the base 102. In one exemplary embodiment, the gap G defines a generally rectangular portion. This assists in the flexibility of the legs 122 during connection to a muntin bar. The gap G becomes larger towards the proximal end 106 of the base 102. It is understood that the legs 122 are resiliently flexible. It is understood that the flexible legs 122 may also be considered flexible fingers of the muntin bar joiner 100.

As further shown in FIGS. 8-12, the bar support member 104 has a central support member 130 having a plurality of fingers 132 extending therefrom thus forming a tree-like shape. It is understood that the fingers 132 are resiliently flexible. In an exemplary embodiment, the bar support member 104 is integral with the base 102 but could be separately attached if desired. The central support 130 has a proximal end 134 generally at the distal end 108 of the base 102 and a distal end 136. The central support 130 has a greater width towards the proximal end 134 and a more narrow width towards the distal end 136. The plurality of fingers 132 includes a first pair of fingers 138 extending from an intermediate portion of the central support 130. The first pair of fingers 138 extend away from the central support 130 and generally towards the base 102. Distal ends 140 of the first pair of fingers 138 extend generally parallel with the central support 130 assisting proper engagement with smaller muntin bars as explained in greater detail below. A second pair of fingers 142 extends outwardly from the central support member 130. The second pair of fingers 142 extends at a greater angle from the support member 130 than the first pair of fingers 138 and the distal ends 144 extend slightly farther from the support member 130 than the distal ends 140 of the first pair of fingers 138. The second pair of fingers 142 is spaced away from the first pair of fingers 138 along the central support member 130. A third pair of fingers 146 extend from the central support member 130 generally at the distal end 136 of the support member 130. The third pair of fingers 146 is structured similarly to the second pair of fingers 142. An extension member 148 is positioned at the distal end 136 of the support member 130 and serves as a stiffening member and lead-in portion of the joiner 100.

As discussed, the muntin bar joiner 100 is typically injected molded in an exemplary embodiment thus producing a single unitary structure. In a preferred embodiment, the muntin bar joiner is formed from polycarbonate. Other materials are also possible such as nylon, acetyl materials as well as other thermoplastic materials. The materials are set such that the joiner has sufficient rigidity for support but also suitable flexibility for proper connection to the muntin bars.

FIGS. 17-22 generally illustrate the muntin bar joiner 100 joining or connecting the first muntin bar 80 and the second muntin bar 82. As described above, it is understood that the muntin bars 80, 82 have a generally tubular configuration and can have varying sizes, including various widths and thicknesses. It is also understood that the first muntin bar 80 may have a first opening 84 in communication with a second opening 86 typically at some desired intermediate location along the first muntin bar 80. The first opening 84 is large enough to accommodate the majority of the joiner structure therethrough. The second muntin bar 82 has an end opening 88.

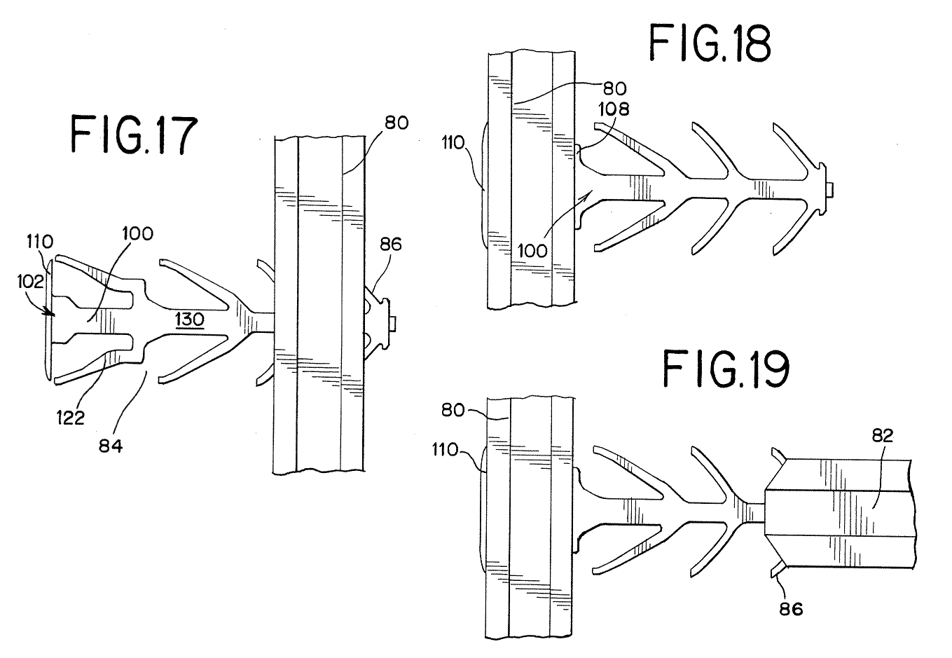

As shown in FIG. 17, the muntin bar joiner 100 is first inserted through the first opening 84 and second opening 86 of the first muntin bar 80. The extension member 148 serves as a lead-in portion and also a stiffening member. The fingers 132 and legs 122 flex inwardly as necessary. The gaps G provide for additional flexibility of the legs 122 inwards towards the base 102. Upon full insertion, portions of the first muntin bar 80 are positioned in the space S between the legs 122 and the cap 110. In one exemplary embodiment, the distal ends of the legs 122 engage an inner surface of the muntin bar 80. In addition, the cap 110 covers the first opening 84 wherein the inner surface 112 of the cap engages an outer surface of the first muntin bar 80. The cap 110 is sized to fully encompass the first opening 84 and extend beyond the peripheral edges in the first muntin bar 80 that define the first opening 84. Thus, the first opening 84 is completely concealed by the cap 110 such as shown in FIGS. 21 and 22. As the cap 110 has a generally low-profile, the cap substantially flush with the outer edge of the first muntin bar 80. The distal end 108 of the base 102 may extend slightly past the second opening 86 in the first muntin bar 80. In addition, the shoulders 120 can be used for centering the muntin bar joiner 100 with smaller muntin bars. As shown in FIG. 18, the muntin bar joiner 100 is secured to the first muntin bar 80. It is understood that the base 102 could have other connection structures with the first muntin bar 80 such as an interference fit structure. The cap 210 could be included to cover the opening 84 in such alternative structure.

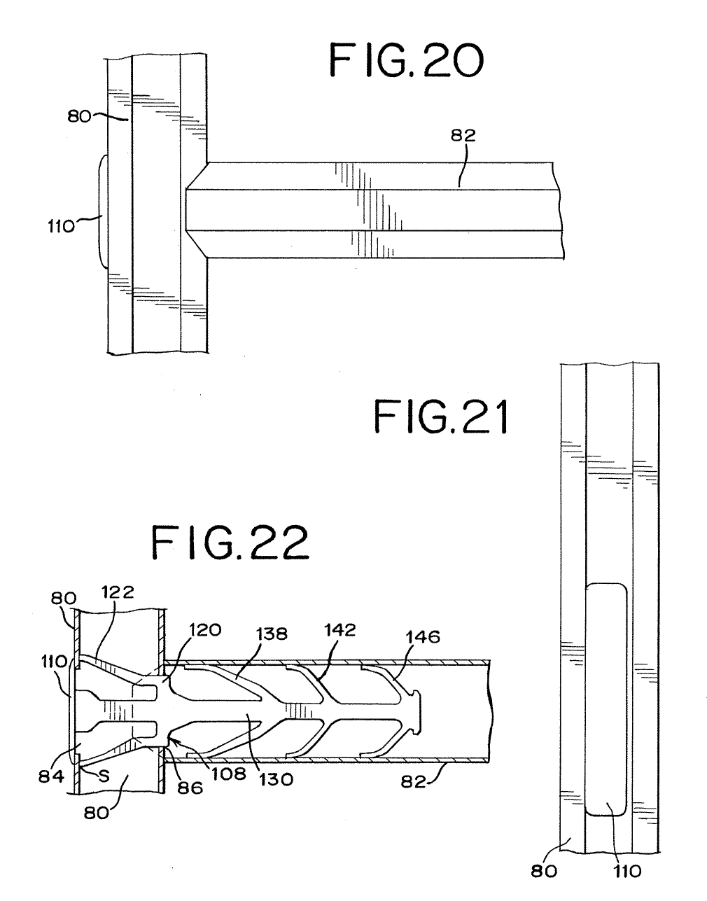

As shown in FIG. 19, the second muntin bar 82 can than be connected to the muntin bar joiner 100. The bar support member 104 is inserted into the end opening 88 of the second muntin bar 82. The plurality of fingers 132 flex inwardly and engage an inner surface of the second muntin bar 82 as can be appreciated from FIGS. 20 and 22. This provides an interference fit thus providing a secure connection between the bar support member 104 and the second muntin bar 82. Distal ends of the first pair of fingers 138 may help reduce any wobbling of the second muntin bar 82 with larger muntin bar sizes. It is also understood that the structural configuration as well as material composition of the fingers 132 are such that the fingers 132 have sufficient flexibility and sufficient stiffness to hold onto the muntin bar, but also do not possess too much resilient flex-back strength wherein the fingers 132 could deform the muntin bars. As shown in FIG. 20, upon full insertion, the end of the second muntin bar 82 extends slightly past the first muntin bar 80 wherein the muntin bar joiner 100 is concealed at the interface area between the first muntin bar 80 and the second muntin bar 82. In this connection, the second muntin bar 82 is generally transverse to the first muntin bar 80. The muntin bar assembly consisting of the first muntin bar 80, the muntin bar joiner 100 and the second muntin bar 82 can then be connected to a sash window 12 with suitable muntin clips such as shown in FIG. 7. It is also understood that the openings in the muntin bar and spacing or structures associated with the muntin bar joiner 100 can be modified wherein the joiner 100 could connect a pair of muntin bars at different angles in addition to a generally transverse configuration.

With the muntin bar joiner 100 of the present invention, an enhanced connection configuration is achieved. The first muntin bar 80 is securely connected to the second muntin bar 82 in an easy, simple installation. A transverse connection is achieved which is desirable in certain types of muntin grids such as shown in FIG. 7. In addition, the cap 110 covers any openings in the muntin bar 80 needed for connection of the muntin bar joiner 100. As the first opening 84 in the first muntin bar 80 would be readily seen in the sash window 12 as it opens up into the area between the panes of glass 24, 26 of the sash window 12, the cap 110 completely covers the opening 84. The cap 110 is a low-profile structure and is substantially flush with the first muntin bar 80. This provides a clean, more aesthetically pleasing look than with prior art connection methods. From certain distances, the cap 110 can easily blend in with the muntin bar 80 making the joiner 100 generally undetectable.

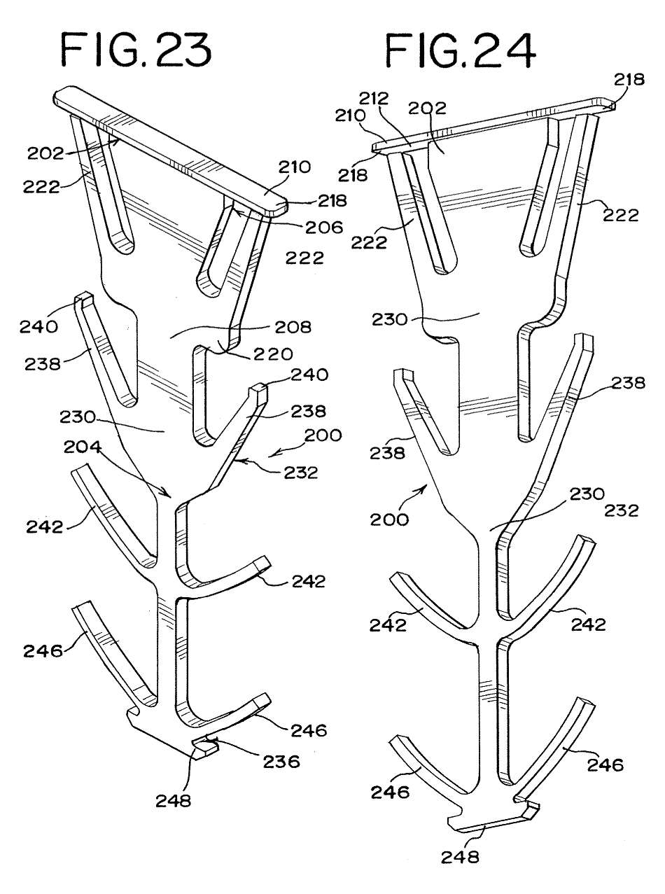

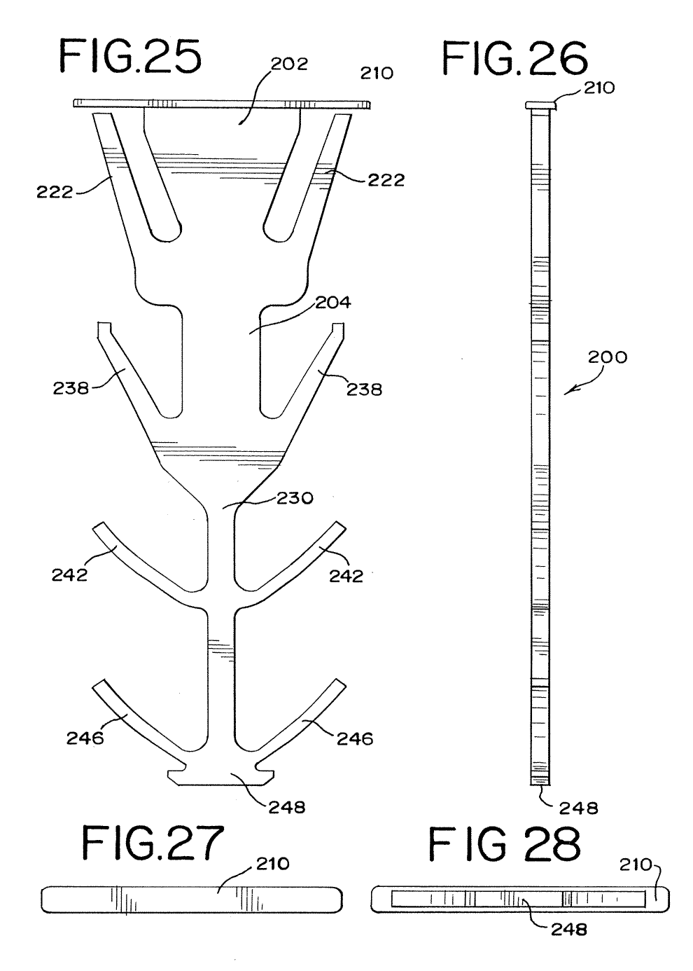

FIGS. 23-28 show another embodiment of the muntin bar joiner generally designated with the reference numeral 200. The muntin bar joiner 200 of this embodiment has similar structure to the muntin bar joiner 100 of FIG. 8 and similar structures will be referred to with similar reference numerals in a 200 series of reference numerals. The muntin bar joiner 200 in this embodiment also connects a first muntin bar 80 and a second muntin bar 82. The muntin bar joiner 100 generally includes a base member 202 and a support member 204.

The base member 202 has a generally bar-shaped structure that supports the support member 204. The base member 202 is dimensioned to fit into an opening provided in the muntin bar. The base 202 has the shoulders 220 and legs 222 extending from the shoulders. The base 202 further has the cap 210 that is dimensioned to fully cover the opening 84 in the first muntin bar 80 similar to the previous embodiment. In this embodiment, the cap 210 is sized such that its ends 218 extend beyond the legs 222. In other words, the legs 222 extend inwards of the ends 218 of the cap 210.

The bar support member 204 has a tree like shape having a plurality of extending fingers like the previous embodiment. In certain embodiments, the legs 222 of the base 202 may be considered as part of plurality of fingers 232. The support member 204 has a central support 230 that is an elongated structure extending from the base 202. The central support 230 is wider at a proximal end closer to the base 202. The support member 204 has the plurality of pairs of fingers 232 that extend from the central support 230. In one preferred embodiment, the support member 204 has three pairs of fingers. The support member 230 has a first pair of fingers 238, a second pair of fingers 242, and a third pair of fingers 246 extending progressively up the central support 230. The pairs of fingers 238, 242, 246 extend at an angle from the central support 106. The first pair of fingers 238 also has a distal end 240 extending in a direction generally parallel to the central support 230. The central support 230 also has the extension member 248 adjacent the third pair of fingers 246 and generally at the distal end 236 of the central support.

As can be appreciated from FIGS. 17-22, the muntin bar joiner 200 connects a pair of muntin bars. The same connection procedure is used as described above. Portions of the first muntin bar 80 are positioned between the cap 210 and the legs 222. The cap 210 of the muntin bar joiner 200 completely covers the first opening 84 in the first muntin bar 80. The plurality of fingers 232 of the bar support 204 are resiliently deflected and engage an inner surface of the second muntin bar 82 in a generally interference type fit. The muntin bar joiner 200 securely connects the first muntin bar 80 to the second muntin bar 82 wherein the second muntin bar 82 is generally transverse to the first muntin bar 80. Other configurations are also possible.

The muntin bar joiners 100, 200 of FIGS. 14-22 and of FIGS. 23-28 provide advantages over prior art muntin bar joiners. The muntin bar joiners replace the two-piece design of the prior art with a once piece design. Prior art muntin bar designs allowed the joiner to be pushed up into the muntin bar without being able to retrieve the joiner easily if the joiner was pushed in too far. The structure of the muntin bar joiners of the present invention snap into the opening of the muntin bar and then hold into place until the second muntin bar is slid onto the support member 104. The structure of the joiners allows for the joiners to be positively snapped into place. In addition, as discussed above, the caps completely cover the opening 84 in the first muntin bar 80 providing a clean aesthetically look.

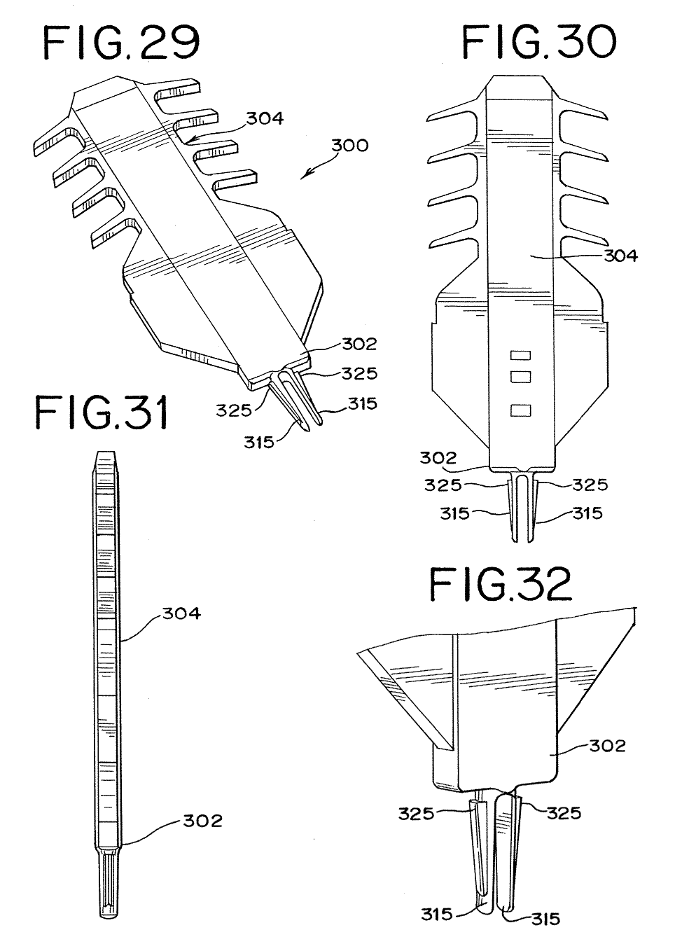

FIGS. 29-32 disclose another embodiment of a muntin bar joiner of the present invention, generally designated with the reference numeral 300. Similar to the previous embodiments, the muntin bar joiner 300 has a base member 302 and a support member 304. The muntin bar joiner 300 is configured to be used with muntin bars having a circular or rounded mounting hole as opposed to the elongated openings such as the openings 84, 86 in the first muntin bar 80. The muntin bar joiner 300 has a pair of posts 315 wherein each post has a ridge structure 325. The bar support 304 also has a plurality of fingers 332 for connecting to a muntin bar. The muntin bar joiner 300 provides for simple easy connections to a pair muntin bars.

As discussed, the muntin bar joiners 100, 200, 300 are typically formed in an injection-molded process. The muntin bar joiner 100 provides for a variety of connections for muntin grids of different configurations.

While the specific embodiments have been illustrated and described, numerous modifications come to mind without significantly departing from the spirit of the invention, and the scope of protection is only limited by the scope of the accompanying Claims.

What is claimed is:

1. A muntin bar joiner for a sash window assembly, the muntin are joiner adapted to connect a first muntin bar to a second muntin bar, the first muntin bar having a first opening in communication with a second opening, the second muntin bar having a first opening, the second muntin bar being generally transverse to the first muntin bar, the joiner comprising:
a base having a proximal end and a distal end, the base having a cap proximate the proximal end; and
a bar support extending from the base,
wherein the base is adapted to be inserted through the first opening and the second opening of the first muntin bar wherein the cap is sized to extend beyond the first opening of the first muntin bar, and wherein the base is adapted to be inserted into the first opening of the second muntin bar wherein the bare support is adapted to engage an inner surface of the second muntin bar.

2. The muntin bar joiner of claim 1 wherein the cap has a generally planar outer surface, the surface adapted to face into the sash window assembly.

3. The muntin bar joiner of claim 2 wherein the cap has rounded peripheral edges.

4. The muntin bar joiner of claim 1 wherein the cap has an inner surface adapted to face and engage an outer surface of the first muntin bar that defines the first opening of the first muntin bar.

5. The muntin bar joiner of claim 1 wherein the base has a pair of flexible legs extending towards the cap and being in confronting relation to an inner surface of the cap.

6. The muntin bar of claim 5 wherein portions of the first muntin bar are adapted to be positioned between the inner surface of the cap and the flexible legs.

7. The muntin bar joiner of claim 1 wherein the base has a pair of shoulders, each shoulder having a flexible leg extending from a respective shoulder wherein a gap is maintained between each shoulder and leg, the legs extending towards the cap and being in confronting relation to an inner surface of the cap.

8. The muntin bar joiner of claim 7 wherein the gap defines a generally rectangular portion.

9. The muntin bar of joiner claim 7 wherein each leg has a first portion extending generally transverse the shoulder and a second portion extending outwardly from the first portion and away from the base.

10. The muntin bar joiner of claim 1 wherein the bar support comprises a plurality of flexible fingers extending from an intermediate portion of the base, the fingers adapted to engage an inner surface of the second muntin bar.

11. The muntin bar joiner of claim 10 wherein the plurality of flexible fingers comprises a first pair of flexible fingers extending from an intermediate portion of the base.

12. The muntin bar joiner of claim 11 wherein the plurality of flexible fingers further comprises a second pair of flexible fingers extending from an intermediate portion of the base, the second pair of flexible fingers being spaced from the first pair of flexible fingers, and a third pair of flexible fingers extending from the base at proximate the distal end of the base.

13. The muntin bar joiner of claim 1 further comprising an extension member positioned at a distal end of the bar support.

14. The muntin bar joiner of claim 5 wherein the legs extend beyond ends of the cap.

15. The muntin bar joiner of claim 5 wherein ends of the cap extends beyond the legs.

16. A three-way muntin bar joiner to connect a first muntin bar to a second muntin bar, the first muntin bar having a first opening in communication with a second opening, the second muntin bar having a first opening and being generally transverse to the first muntin bar, the muntin bar joiner comprising:
a base having a proximal end and a distal end, the base adapted to connected to the first muntin bar, the base having a cap proximate the proximal end, the base further having a pair of shoulders, each shoulder having a flexible leg extending from a respective shoulder wherein a gap is maintained between each shoulder and legs, the legs extending towards the cap and being in confronting relation to an inner surface of the cap;
a bar support connected to the base and having a first pair of flexible fingers extending therefrom;
a second pair of flexible fingers extending from the bar support, the second pair of flexible fingers being spaced from the first pair of flexible fingers;
a third pair of flexible fingers extending from the bar support at proximate a distal end of the bar support; and
an extension member positioned at a distal end of the bar support,
wherein the base is adapted to be inserted through the first opening and the second opening of the first muntin bar wherein portions of the first muntin bar is adapted to be positioned between the legs and the cap and wherein the cap is sized to extend beyond the first opening of the first muntin bar, and wherein the base is adapted to be inserted into the first opening of the second muntin bar wherein the flexible fingers are adapted to be placed in a flexed position to engage an inner surface of the second muntin bar.

17. A muntin bar assembly for a sash window assembly, the muntin bar assembly comprising:
a first muntin bar adapted to be connected to the sash window assembly, the first muntin bar having a first opening in communication with a second opening;
a second muntin bar having a first opening;
a muntin bar joiner comprising:
a base having a proximal end and a distal end, the base having a cap proximate the proximal end, the base further having pair of flexible legs extending towards the cap and being in confronting relation to an inner surface of the cap;
a bar support connected to the base and having a pair of flexible fingers extending therefrom,
wherein the base is inserted through the first opening and the second opening of the first muntin bar wherein portions of the first muntin bar are positioned between the legs and the cap and wherein the cap is sized to extend beyond the first opening of the first muntin bar, and wherein the base is adapted to be inserted into the first opening of the second muntin bar wherein the flexible fingers are placed in a flexed position and engage an inner surface of the second muntin bar.
